(19) United States
(12) Patent Application Publication
(10) Pub. No.: US 2009/0001743 A1
(43) Pub. Date: Jan. 1, 2009

(54) LOAD BEARING COVER ASSEMBLY HAVING SUPPORT RIBS THAT FACILITATE CARGO MANAGEMENT

(75) Inventors: Alan Sturt, West Bloomfield, MI (US); Christopher Jones, Southfield, MI (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: International Automotive Components Group North America, Inc., Dearborn, MI (US)

(21) Appl. No.: 11/770,189

(22) Filed: Jun. 28, 2007

(51) Int. Cl. B62D 33/08

(52) U.S. Cl. 296/26.01

(57) ABSTRACT

A load bearing cover assembly for use with a vehicle having a floor, having a storage compartment. The load bearing cover assembly includes a cover member having a first side and a second side opposite the first side, the cover member being substantially rigid and adapted for connection to the vehicle such that the cover member may be positioned to at least partially cover the storage compartment, a first support rib may be attached to the first side of the cover member; and a second support rib may be attached to the second side of the cover member, the first support rib and the second support rib each having an aperture for selectively attaching a cargo securing member.

### BACKGROUND OF THE INVENTION

1. Field of the Invention

The field of this invention relates to cover assemblies that cover storage compartments and that are reinforced with support ribs that can facilitate cargo management.

2. Background Art

A load bearing cargo cover assembly having cargo rails is disclosed herein. Examples of cargo covering assemblies are disclosed in U.S. Pat. Nos. 6,082,800; 6,338,518; and 7,121,603, and in U.S. Patent Application Publication Nos. 2002/0025237; 2004/0105744; and 2005/0175426.

### SUMMARY OF THE INVENTION

In a first embodiment, a load bearing cover assembly for use with a vehicle having a floor having a storage compartment is provided. In the first embodiment, the load bearing cover assembly comprises a cover member having a first side and a second side opposite the first side. The cover member may be substantially rigid and may be adapted for connection to the vehicle such that the cover member may be positioned to at least partially cover the storage compartment. A first support rib may be attached to the first side of the cover member and the second support rib may be attached to the second side of the cover member. The first support rib and the second support rib may each have an aperture for selectively attaching a cargo securing member.

In at least one implementation of the first embodiment, the second support rib may be disposed substantially opposite the first support rib and may be substantially aligned therewith.

In another implementation of the first embodiment, the first support rib and the second support rib each have a plurality of the apertures. In another implementation of the first embodiment, the aperture in the first support rib is a slot.

In another implementation of the first embodiment, the cover member may be substantially planar. The first side may have a plurality of the first support ribs, with each of the first support ribs having a plurality of the apertures. The second side may have a plurality of the second support ribs, and each of the second support ribs may have a plurality of the apertures. In this implementation, the plurality of the first support ribs may be substantially aligned and substantially parallel with each other. Also, the plurality of the second support ribs may be substantially aligned and substantially parallel with each other.

In another implementation of the first embodiment, the cover member may be partially hollow and partially solid. In this implementation, the first and second support ribs may be attached to a solid portion of the cover member. In at least one variation of this implementation, the second support rib may be disposed substantially opposite the first support rib. Additionally, the first support rib has a surface that may be substantially flush with the first side and the second support rib has a surface that may be substantially flush with the second side.

In another implementation of the embodiment, the first support rib may be recessed within the first side. In this implementation, a surface of the first support rib may be substantially flush with the first side. In a variation of this implementation, the second support rib may be recessed within the second side. In this implementation, a surface of the second support rib may be substantially flush with the second side. Additionally, the second support rib may be disposed substantially opposite the first support rib and may be substantially aligned therewith.

In at least another implementation of the first embodiment, the cover member may be configured to move between a cover position and an upright position. The cover member may cover at least a portion of the storage compartment when the cover member is disposed in the cover position and the cover member may expose at least a portion of the storage compartment when the cover member is in the upright position. In at least one variation of this implementation, the cover assembly further comprises a support member that may be disposed proximate an end of the cover member. The support member may support the cover member in a substantially horizontal orientation when the cover member is in the cover position.

In at least another implementation of the first embodiment, the first and second support ribs may have a substantially arcuate cross section.

In at least a second embodiment, a load bearing cover assembly for use with a vehicle having a floor having a storage compartment is provided. The load bearing cover assembly comprises a substantially planar cover member having a first side and a second side opposite the first side. The cover member may be substantially rigid and may have a protrusion for docking with the vehicle such that a user may selectively position the cover member in a first position that at least partially covers the storage compartment. The cover member may further have an attaching member on the second side such that a user may selectively attach the cover member to the vehicle in a second position that at least partially exposes the storage compartment. Additionally, a first support rib may be attached to the first side of the cover member and a second support rib may be attached to the second side of the cover member. The second support rib may be disposed substantially opposite the first support rib and may be substantially aligned therewith.

In at least one implementation of the second embodiment, the first support rib and the second support rib each have an attachment aperture for receiving an attachment feature of a selectively attachable cargo restraining member.

In at least another implementation of the second embodiment, the first rib and the second support rib each have a plurality of the attachment apertures.

In another implementation of the second embodiment, the load bearing cover assembly further comprises a plurality of the first support ribs and a plurality of the second support ribs. The plurality of the first support ribs may be attached to the first side and may be substantially aligned with each other. The plurality of the second support ribs may be attached to the second side and may be substantially aligned with each other. Additionally, each one of the second support ribs may be disposed substantially opposite a corresponding one of the first support ribs.

In at third embodiment, a load bearing cover assembly for use with a vehicle having a floor, a seat mounted on the floor, and a storage compartment recessed within the floor rearward of the seat is provided. In this third embodiment, the load bearing cover assembly may comprise a substantially planar cover member having a top side and a bottom side opposite the top side, the cover member being substantially rigid. A plurality of first support ribs may be attached to the top side and the plurality of support ribs may have a means for docking with a cargo restraining member. A plurality of second support ribs may be attached to the bottom side. The plurality of second support ribs may have a means for docking with the cargo restraining member. A connector may be attached to the cover member for connecting the cover member to the seat. The cover member may be selectively moveable between a cover position covering a portion of the storage compartment and an upright position exposing a portion of the storage compartment. The top side may face substantially upwards when the cover member is in the cover position. The bottom side may face substantially to the rear of the vehicle when the cover member is in the upright position.

In at least one implementation of the third embodiment, the cover member may have a plurality of hollow portions and plurality of solid portions configured such that each of the solid portions may lie within a single plane. The single plane may bisect each of the hollow portions. Each of the plurality of the first support ribs may be attached to a respective one of the solid portions. Each of the plurality of the second support ribs may also be attached to a respective one of the solid portions. Each of the plurality of the first support ribs may be substantially opposite and substantially aligned with a corresponding one of the plurality of the second support ribs.

In at least another implementation of the third embodiment, the cover member may be capable of supporting a load of 150 kg when the cover member is in the cover position. In at least one variation of this implementation, the cover member may be capable of supporting a load of 225 kg when the cover member is in the cover position.

### BRIEF DESCRIPTION OF THE DRAWINGS

FIG. 1 is a fragmentary perspective view of the vehicle equipped with an embodiment of the load bearing cargo assembly of the present invention;

FIG. 2 is a fragmentary perspective view of the vehicle of FIG. 1 illustrating the vehicle's seats and the load bearing cover assembly in a fold-flat configuration;

FIG. 3 is a fragmentary perspective view illustrating an alternate embodiment of the load bearing cover assembly in an upright configuration;

FIG. 4 is a fragmentary perspective view illustrating the load bearing cover assembly of FIG. 3 as it is repositioned into a covering configuration;

FIG. 5 is a fragmentary cross-sectional view taken along the line 5-5 in FIG. 1;

FIG. 6 is a fragmentary perspective view of a support rib; and

FIG. 7 is partially a fragmentary cross-sectional view taken along the line 7-7 in FIG. 6 and partially a perspective view illustrating a cargo restraining device docked with the support rib of FIG. 6.

### DETAILED DESCRIPTION OF THE PREFERRED EMBODIMENT(S)

Detailed embodiments of the present invention are disclosed herein; however, it is to be understood that the disclosed embodiments are merely exemplary of the invention that may be embodied in various and alternative forms. The figures are not necessarily drawn to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

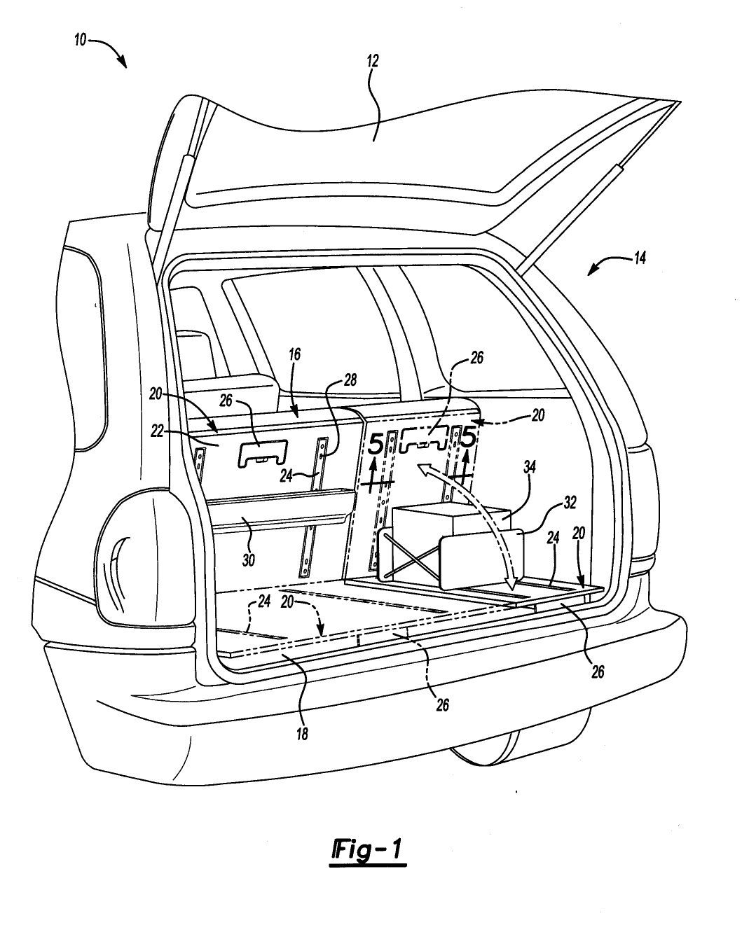

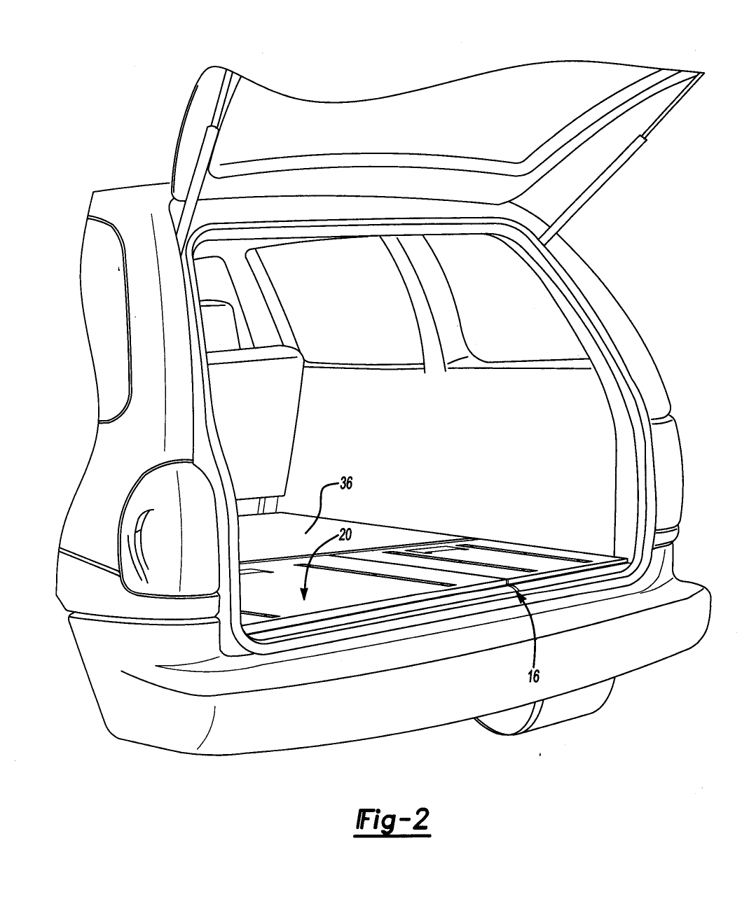

Many vehicles include rear seats that fold flat into a compartment disposed rearward of the seat to provide additional cargo space and a flat load floor. When the rear seats are in their deployed position, the compartment rearward of the rear seats may receive cargo. With reference to FIGS. 1 and 2, a rear portion of a vehicle 10 equipped with fold-flat rear seats is illustrated. A rear hatch 12 is movable between an open position and a closed position and is illustrated in the open position. With rear hatch 12 open, a user has access to the cargo portion 14 of vehicle 10.

Vehicle 10 includes a rear seat assembly 16. In the illustrated embodiment, rear seat assembly 16 is split into separate portions which may be independently stored or deployed. In other vehicles, rear seat assembly 16 may be a single bench. In still other vehicles, rear seat assembly 16 may consist of two separate single or bucket type seats.

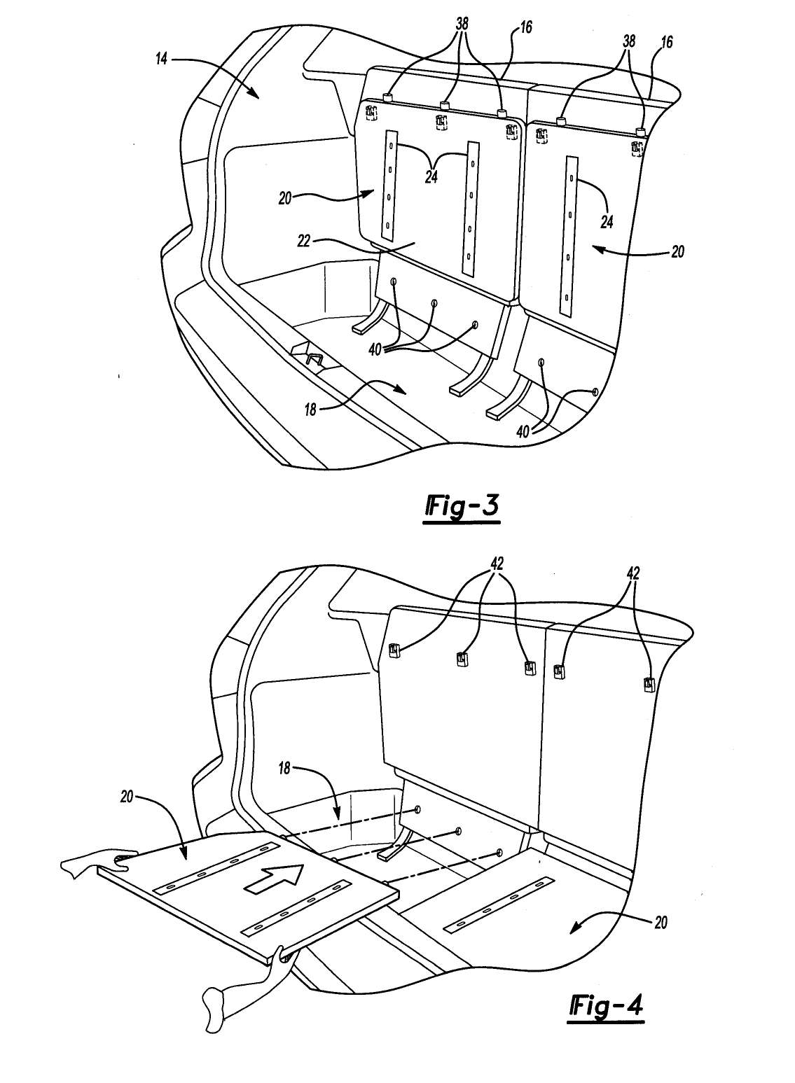

An in-floor cargo compartment 18 (best shown in FIGS. 3 and 4) is disposed rearward of rear seat assembly 16. Rear seat assembly 16 may be folded flat and stored in the in-floor cargo compartment 18 as illustrated in FIG. 2. As illustrated in FIG. 2, when rear seat assembly 16 is stored in in-floor cargo compartment 18, a seat back portion of rear seat assembly 16 faces upward to become the cargo floor of vehicle 10. In other embodiments of rear seat assembly 16, a seat bottom portion of rear seat assembly 16 may face upward and serve as the cargo floor when rear seat assembly 16 is stored in the in-floor cargo compartment 18.

An embodiment of a load bearing cover assembly 20 of the present invention is attached to the seat back portion of rear seat assembly 16. Load bearing cover assembly 20 may include a cover member 22 and at least one support rib or cargo rail 24. In the embodiment illustrated in FIG. 1, four support ribs 24 are provided on each cover member 22, two first support ribs disposed on a first or top side that faces the seat back portion of rear seat assembly 16 and two second support ribs disposed on a second or bottom side that faces away from rear seat assembly 16. Two load bearing cover assemblies 20 are included in the illustrated embodiment to correspond with the two sections of rear seat assembly 16. In vehicles where rear seat assembly 16 is a single bench, a single load bearing cover assembly 20 may be used. The separate load bearing cover assemblies 20 illustrated in FIG. 1 may be independently operated to permit the separate sections of rear seat assembly 16 to be independently deployed or stored.

Load bearing cover assembly 20 may pivot between a first or upright position and a second or cover position. When in the upright position, the load bearing cover assembly 20 may be positioned substantially adjacent to the seat back portion of rear seat assembly 16. When in the cover position, load bearing cover assembly 20 may be substantially horizontal and may cover at least a portion of in-floor cargo compartment 18. Load bearing cover assembly 20 may support cargo disposed on the first surface when load bearing cover assembly 20 is in the cover position. Load bearing cover assembly 20 may also conceal and/or contain cargo stored in the in-floor cargo compartment 18 while in the cover position.

A support member 26 supports the load bearing cover assembly 20 in a substantially horizontal position when load bearing cover assembly 20 is in the cover position. In other embodiments, load bearing cover assembly 20 may not require support member 26 to maintain a substantially horizontal orientation when in the cover position. In other embodiments, the seat back portion of rear seat assembly 16 may fold over on top of the seat bottom portion to provide a surface for storage of cargo on top of the seat back portion. When in this position, the load bearing cover assembly 20 may require support member 26 to hold load bearing cover assembly 20 in a position that is substantially level with the seat back portion of rear seat assembly 16 such that the seat back portion and the load bearing cover assembly 20 together form a substantially contiguous flat surface.

In the embodiment illustrated in FIG. 1, support member 26 is attached to cover member 22 and may be selectively pivoted in and out of a recessed position. In this configuration, support member 26 may be flush with a side of the load bearing cover assembly 20 when load bearing cover assembly 20 is in the upright position to avoid obstructing the storage of cargo or the attachment of cargo containers. As load bearing cover assembly 20 is pivoted to the cover position, a user may fold out support member 26 which may engage and be supported by an internal surface of vehicle 10. In other embodiments, support member 26 may be attached to a portion of the in-floor cargo compartment 18 or another surface within vehicle 10 proximate to in-floor cargo compartment 18 and may be deployed to dock with load bearing cover assembly 20 when load bearing cover assembly 20 is moved to the cover position.

Support rib 24 reinforces cover member 22 to provide increased structural stability to load bearing cover assembly 20 which assists load bearing cover assembly 20 to support a load while in the cover position. As illustrated in FIG. 1, a plurality of support ribs 24 are attached to both a front side and a rear side of cover member 22. In other embodiments, a greater or lesser number of support ribs may be utilized. Additionally, while support ribs 24 are illustrated as being substantially aligned with a longitudinal axis of cover member 22, in other embodiments, support ribs 24 may be attached to cover member 22 in an orientation that is at least partially transverse to the longitudinal axis of cover member 22. In still other embodiments, support ribs 24 may be attached to cover member 22 in an orientation that is substantially perpendicular to the longitudinal axis of cover member 22.

Support rib 24 includes a plurality of apertures 28 which permit the attachment of cargo containers to support ribs 24. Other mechanisms for docking with cargo containers may be used. For example, the support rib 24 may include a plurality of male or female snap portions to mate with corresponding female or male snap portions on a cargo container. Interlocking hooks or other protrusions may be used. Hook and loop type fasteners such as velcro™ may be used to restrain cargo containers. Instead of apertures 28, support rib 24 may include protrusions to dock with apertures in the cargo containers. Interlocking teeth such as those found in a zipper may be used to secure cargo containers. Suction cups may be used to secure cargo containers. Twist-type fasteners may also be used to secure cargo container to the support rib 24.

By aligning support ribs 24 along their respective apertures, the support ribs 24 may cooperate with one another to support a cargo container. By attaching support ribs 24 to both the first and second sides of cover member 22, cargo containers may be attached to both sides of load bearing cover assembly 20. As illustrated, shelf 30 extends between two support ribs 24 and is configured to contain cargo while load bearing cover assembly 20 is in the upright position. A drawer 32 is configured to dock with the apertures 28 of support rib 24 while the load bearing cover assembly 20 is in the cover position. In this configuration, drawer 32 can contain cargo item 34 to prevent it from moving during vehicle operations. By providing a plurality of apertures 28 in each support rib 24, cargo containers may be adjusted to different heights when the load bearing cover assembly 20 is in the upright position and to different lateral positions when load bearing cover assembly 20 is in the cover assembly.

With reference to FIG. 2, rear seat assembly 16 is illustrated in the fold-flat position, recessed within in-floor cargo compartment 18. In this configuration, the second side of load bearing cover assembly 20 faces in a generally upward direction and serves as a portion of the cargo floor. In this configuration, load bearing cover assembly 20 is substantially contiguous with a floor 36 of vehicle 10.

With reference to FIGS. 3 and 4, a second embodiment of load bearing cover assembly 20 is illustrated. Load bearing cover assembly 20 may include a plurality of protrusions 38 which protrude from an upper edge of cover member 22. Rear seat assembly 16 may include a plurality of protrusion receivers 40 which are configured to receive protrusions 38. Cover member 22 may be suspended in the upright position to rear seat assembly 16 by a plurality of hooks 42 attached to a seat back portion of rear seat assembly 16. A user desiring to move load bearing cover assembly 20 into the cover position would lift cover member 22 from its engagement with hooks 42 and reposition the load bearing cover assembly 20 into the cover position by aligning and inserting protrusions 38 into protrusion receivers 40 as indicated in FIG. 4.

In other embodiments, different types of protrusions 38 and protrusion receivers 40 may be utilized. For instance, rather than a plurality of protrusions 38, a single tab affixed to cover member 22 may dock with a single slot disposed on rear seat assembly 16. Alternatively, the protrusion receivers 40 may be disposed in a portion of in-floor cargo compartment 18. In other embodiments, protrusions 38 may protrude downwardly from a lower edge of cover member 22. In still other embodiments, the protrusions 38 may be disposed on vehicle floor 36 or within in-floor cargo compartment 18 and protrusion receiver 40 may be defined within cover member 22. Also the hooks 42 may be disposed on cover member 22 and hook receivers may be recessed within a surface of the rear seat assembly 16. In other embodiments, restraints other than hooks and receivers may be utilized to secure cover member 22 to rear seat assembly 16.

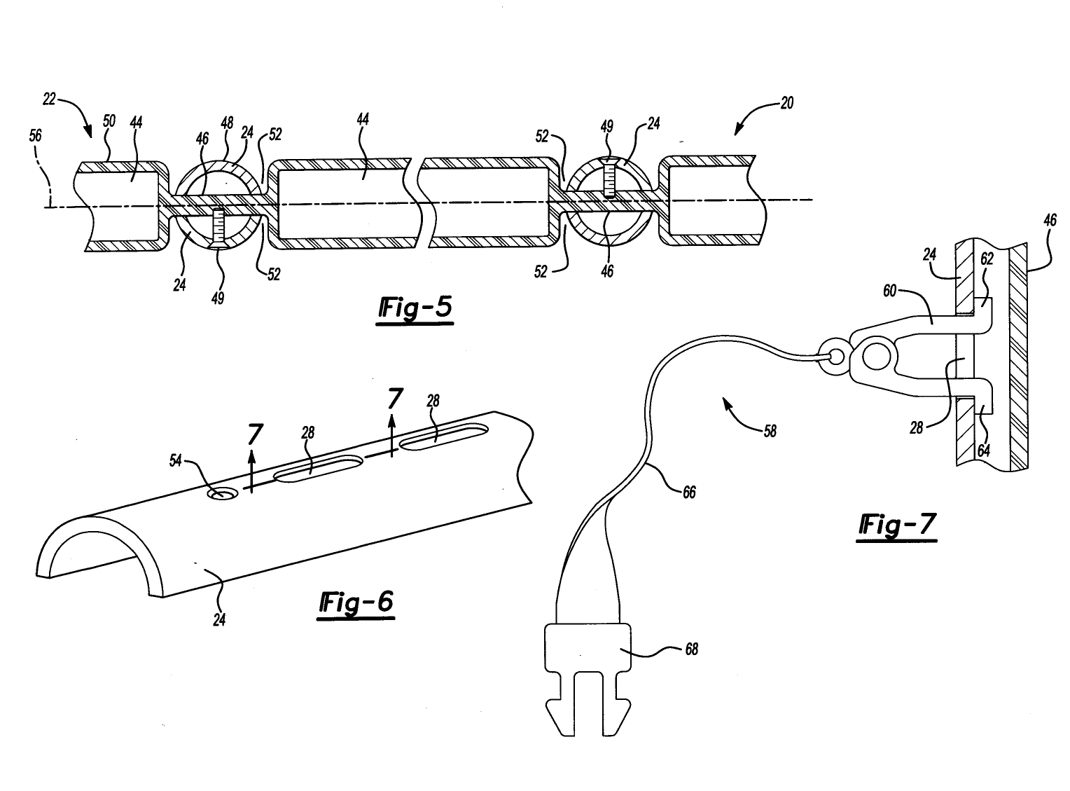

FIG. 5 illustrates a cross-section of an embodiment of load bearing cover assembly 20. Load bearing cover assembly 20 includes a plurality of hollow portions 44 and solid portions 46. Cover member 22 may be made from a polymeric material and may be formed by any one of a number of processes including blow molding to form the plurality of hollow portions 44. In other embodiments, cover member 22 may be completely solid. In some embodiments, the cover member 22 may be made from a material comprising polypropylene or glass-filled polypropylene and support ribs 24 may be made from steel, aluminum or anodized aluminum. Support ribs 24 are fastened to the solid portions 46 via fasteners 49. The solid portions 46 have a generally narrower thickness than the hollow portions 44. This disparity in thickness forms channels 52 in cover member 22 between individual hollow portions 44 where support ribs 24 may be attached. In the illustrated configuration, an uppermost surface 48 of support rib 24 does not protrude beyond, and is substantially flush with, cover member surface 50. In this configuration, the support ribs 24 do not impede the movement of cargo across the cover member surface 50 while cover member 22 is in the cover position. In other embodiments, uppermost surface 48 of support rib 24 may be recessed below cover member surface 50 and other embodiments, uppermost surface 48 of support rib 24 may protrude beyond cover member surface 50.

As illustrated in FIG. 5, load bearing cover assembly 20 is substantially symmetrical about a plane 56 which bisects cover member 22. The solid portions 46 of cover member 22 are all aligned along plane 56 and each channel 52 is illustrated as having substantially equal depth. In other embodiments, load bearing cover assembly 20 may not be symmetrical about plane 56. In those embodiments, plane 56 may be nearer or further from cover member surface 50 with the result that channels 52 on side one of cover member 22 may have a depth greater than or less than channels 52 on the second side of cover member 22.

FIG. 6 illustrates an embodiment of a support rib 24. In the illustrated embodiment, support rib 24 has an arcuate cross-section. In other embodiments, support rib 24 may be flat, rectilinear, partially rectilinear or may have any other geometric configuration. Support rib 24 includes a plurality of apertures 28 to permit the docking of cargo containers with support ribs 24. Aperture 28 is a longitudinally oriented slot. In other configurations, aperture 28 may be oriented transverse or perpendicular to a longitudinal axis of support rib 24. In other embodiments, aperture 28 may be substantially circular. Support rib 24 includes a fastener aperture 54 to permit support rib 24 to be affixed to cover member 22.

FIG. 7 illustrates a cross-sectional view taken along the line 7-7 of FIG. 6 illustrating a connector assembly 58 connected to support rib 24 at an aperture 28. Connector assembly 58 includes a connector portion 60 having first and second opposing flanges 62, 64 which may be squeezed together to bring first and second opposing flanges 62 and 64 together to permit them to fit through aperture 28. Once inserted through aperture 28, connector portion 60 may be released, permitting first and second flanges 62 and 64 to move apart and engage support rib 24. Connector assembly 58 may further include a tether 66 and an engagement head 68 for attaching to cargo items. Tether 66 may be elastic.

The use of support ribs 24 together with cover member 22 may provide a relatively strong load platform. In some embodiments, the load bearing cover assembly 20 may be able to support loads up to and including 225 kilograms when the load bearing cover assembly 20 is in the cover position.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A load bearing cover assembly for use with a vehicle having a floor having a storage compartment, the load bearing cover assembly comprising:
a cover member having a first side and a second side opposite the first side, the cover member being substantially rigid and adapted for connection to the vehicle such that the cover member may be positioned to at least partially cover the storage compartment;
a first support rib attached to the first side of the cover member; and
a second support rib attached to the second side of the cover member, the first support rib and the second support rib each having an aperture for selectively attaching a cargo securing member.

2. The load bearing cover assembly of claim 1 wherein the second support rib is disposed substantially opposite the first support rib and substantially aligned therewith.

3. The load bearing cover assembly of claim 1 wherein the first support rib and the second support rib each have a plurality of the apertures.

4. The load bearing cover assembly of claim 1 wherein the aperture in the first support rib is a slot.

5. The load bearing cover assembly of claim 1 wherein the cover member is substantially planar, wherein the first side has a plurality of the first support ribs, each of the first support ribs having a plurality of the apertures, wherein the second side has a plurality of the second support ribs, each of the second support ribs having a plurality of the apertures, wherein the plurality of the first support ribs are substantially aligned and substantially parallel with each other and wherein the plurality of the second support ribs are substantially aligned and substantially parallel with each other.

6. The load bearing cover assembly of claim 1 wherein the cover member is partially hollow and partially solid and wherein the first and second support ribs are attached to a solid portion of the cover member.

7. The load bearing cover assembly of claim 6 wherein the second support rib is disposed substantially opposite the first support rib and wherein the first support rib has a surface that is substantially flush with the first side and wherein the second support rib has a surface that is substantially flush with the second side.

8. The load bearing cover assembly of claim 1 wherein the first support rib is recessed within the first side and wherein a surface of the first support rib is substantially flush with the first side.

9. The load bearing cover assembly of claim 8 wherein the second support rib is recessed within the second side, wherein a surface of the second support rib is substantially flush with the second side, and wherein the second support rib is disposed substantially opposite the first support rib and is substantially aligned therewith.

10. The load bearing cover assembly of claim 1 wherein the cover member is configured to move between a cover position and an upright position, the cover member covering at least a portion of the storage compartment when disposed in the cover position and exposing at least a portion of the storage compartment when the cover member is in the upright position.

11. The load bearing cover assembly of claim 10 further comprising a support member disposed proximate an end of the cover member, the support member supporting the cover member in a substantially horizontal orientation when the cover member is in the cover position.

12. The load bearing cover assembly of claim 1 wherein the first and second support ribs have a substantially arcuate cross section.

13. A load bearing cover assembly for use with a vehicle having a floor having a storage compartment, the load bearing cover assembly comprising:
a substantially planar cover member having a first side and a second side opposite the first side, the cover member being substantially rigid and having a protrusion for docking with the vehicle such that a user may selectively position the cover member in a first position that at least partially covers the storage compartment and the cover member further having an attaching member on the second side such that a user may selectively attach the cover member to the vehicle in a second position that at least partially exposes the storage compartment;
a first support rib attached to the first side of the cover member; and
a second support rib attached to the second side of the cover member, the second support rib being disposed substantially opposite the first support rib and being substantially aligned therewith.

14. The load bearing cover assembly of claim 13 wherein the first support rib and the second support rib each have an attachment aperture for receiving an attachment feature of a selectively attachable cargo restraining member.

15. The load bearing cover assembly of claim 14 wherein the first support rib and the second support rib each have a plurality of the attachment apertures.

16. The load bearing cover assembly of claim 13 further comprising a plurality of the first support ribs and a plurality of the second support ribs, the plurality of the first support ribs being attached to the first side and being substantially aligned with each other, the plurality of the second support ribs being attached to the second side and being substantially aligned with each other, wherein each one of the second support ribs is disposed substantially opposite a corresponding one of the first support ribs.

17. A load bearing cover assembly for use with a vehicle having a floor, a seat mounted on the floor and a storage compartment recessed within the floor rearward of the seat, the load bearing cover assembly comprising:
a substantially planar cover member having a top side and a bottom side opposite the top side, the cover member being substantially rigid;
a plurality of first support ribs attached to the top side, the plurality of support ribs having a means for docking with a cargo restraining member;
a plurality of second support ribs attached to the bottom side, the plurality of second support ribs having a means for docking with the cargo restraining member; and
a connector attached to the cover member for connecting the cover member to the seat,
the cover member being selectively moveable between a cover position covering a portion of the storage compartment and an upright position exposing a portion of the storage compartment, the top side facing substantially upwards when the cover member is in the cover position and the bottom side facing substantially to the rear of the vehicle when the cover member is in the upright position.

18. The load bearing cover assembly of claim 17 wherein the cover member has a plurality of hollow portions and plurality of solid portions configured such that each of the solid portions lie in a single plane and the single plane bisects each of the hollow portions, wherein each of the plurality of the first support ribs attached to a respective one of the solid portions and wherein each of the plurality of the second support ribs is attached to a respective one of the solid portions, each one of the plurality of the first support ribs being substantially opposite and substantially aligned with a corresponding one of the plurality of the second support ribs.

19. The load bearing cover assembly of claim 17 wherein the cover member can support a load of 150 kg when the cover member is in the cover position.

20. The load bearing cover assembly of claim 19 wherein the cover member can support a load of 225 kg when the cover member is in the cover position.
